(19) United States
(12) Patent Application Publication
(10) Pub. No.: US 2012/0125843 A1
(43) Pub. Date: May 24, 2012

(54) METHODS AND MATERIALS FOR PERFORMING HYDROPHOBIC INTERACTION CHROMATOGRAPHY

(75) Inventors: Edouard S. P. Bouvier, Stow, MA (US); Hua Yang, Franklin, MA (US)

(73) Assignee: Waters Technologies Corporation, Milford, MA (US)

(21) Appl. No.: 13/336,009

(22) Filed: Dec. 23, 2011

Related U.S. Application Data
(63) Continuation-in-part of application No. PCT/US2010/060557, filed on Dec. 15, 2010.
(60) Provisional application No. 61/286,582, filed on Dec. 15, 2009.
(60) Provisional application No. 61/355,970, filed on Jun. 17, 2010.

(51) Int. Cl. B01D 15/08

(52) U.S. Cl. 210/635; 210/198.2

(57) ABSTRACT

A method for performing hydrophobic interaction chromatography includes providing at least one wall defining a chamber having an inlet and an exit, and a stationary phase disposed within the chamber. The stationary phase comprises particles or monolith having a hydrophobic surface and a hydrophilic ligand. The method also includes loading a sample onto the stationary phase in the chamber and flowing the sample over the stationary phase. The sample is separated into one or more compositions by hydrophobic interaction between the stationary phase and the one or more compositions.

### CROSS-REFERENCE TO RELATED APPLICATIONS

This application is a continuation-in-part of International Application No. PCT/US2010/060557 filed Dec. 15, 2010, and also claims benefit of priority to U.S. Provisional Patent Application Nos. 61/286,582, filed Dec. 15, 2009, and 61/355,970, filed Jun. 17, 2010, all of which are owned by the assignee of the instant application and incorporated herein by reference in their entirety.

### FIELD OF THE TECHNOLOGY

The present technology relates generally to methods and materials for performing hydrophobic interaction chromatography and, more particularly, to methods for performing hydrophobic interaction chromatography using a stationary phase that comprises particles with a hydrophobic surface and a plurality of hydrophilic ligands attached thereto.

### BACKGROUND OF THE TECHNOLOGY

Chromatography is a separation method that can be used for concentrating or isolating one or more compounds found in a mixture or sample. The term “sample” broadly includes any mixture which an individual desires to analyze. The term “mixture” includes a fluid containing one or more dissolved compounds. The fluid can comprise water and/or other liquids and gases. A compound of interest can be referred to as an analyte.

Chromatography is a differential migration process. Compounds in a mixture traverse a chromatographic column at different rates, which leads to their separation. The migration occurs by convection of a fluid phase, referred to as the mobile phase, in relationship to a packed bed of particles or a porous monolith structure, referred to as the stationary phase. In some modes of chromatography, differential migration occurs by differences in affinity of analytes with the stationary phase and mobile phase.

Hydrophobic Interaction Chromatography (HIC) is a technique used for separating and characterizing compounds such as biomolecules (e.g., proteins, peptides, and DNA) by their degree of hydrophobicity. Typically, the HIC stationary phase is comprised of a bonded phase on a support particle that contains both hydrophobic and hydrophilic regions.

HIC operates through a combination of the hydrophobic/hydrophilic properties of the solid phase, together with the properties of the mobile phase (e.g., salt concentration/gradient). In HIC, the hydrophobic interaction between the stationary phase and the analyte can be relatively weak. However, high salt concentrations can enhance hydrophobic interactions, increasing the aggregation of hydrophobic regions. Thus, under high salt aqueous conditions, molecules with hydrophobic properties are attracted to the relatively hydrophobic stationary phase. Different molecules can then subsequently be released, in order of increasing hydrophobicity, from the stationary phase by decreasing the salt concentration of the mobile phase. At the point where there is little or no salt in the mobile phase, most of the molecules will be released from the stationary phase. Additionally, elution can also be achieved and/or facilitated through the use of mild organic modifiers or detergents.

FIG. 1 shows a prior art HIC stationary phase 100. The stationary phase 100 includes a base particle 105 that can comprise, for example, polymer, silica, or agarose. The stationary phase 100 also includes a hydrophilic layer 110 and a hydrophobic ligand 115. The base particle 100 can comprise, for example, sepharose, polystyrene/divinylbenzene, polymethacrylate, silica, or polymethacrylate. The hydrophobic ligand 115 can comprise, for example, phenyl, butyl, octyl, ether, isopropyl, hexyl, PPG, amide/ethyl, methyl, ethyl, propyl, or t-butyl.

HIC is normally performed using a column having a packed bed of particles. The packed bed of particles is used as a separation media or stationary phase through which the mobile phase can flow. The column can be placed in fluid communication with a pump and a sample injector. The sample mixture can be loaded onto the column under pressure by the sample injector and the mixture and mobile phase are pushed through the column by the pump. The compounds in the mixture elute from the column in order of increasing hydrophobicity as the salt concentration is gradually deceased.

Typically, the column is placed in fluid communication with a detector, which can detect the change in a property of the solution as the solution exits the column. The detector can register and record these changes as a plot, referred to as a chromatogram, which is used to determine the presence or absence of the analyte. The time at which the analyte leaves the column is an indication of the hydrophobicity of the molecule. A non-limiting example of a detector used for HIC is a UV detector.

Prior art HIC separations are generally time-consuming and inefficient.

### SUMMARY OF THE TECHNOLOGY

The technology, in various embodiments, provides HIC media and methods using a stationary phase that comprises particles with a hydrophobic surface and a plurality of hydrophilic ligands attached thereto. In one example embodiment, diol-coated Ethylene Bridged Hybrid (BEH) particles are used as a HIC stationary phase. One advantage of the HIC media of the technology lies in the balance between the hydrophilic coating and the hydrophobic base particle—unlike the prior art, the technology does not require the amount of surface hydrophobicity to be carefully controlled by the difficult process of reproducibly bonding small amounts of hydrophobic functional groups to the stationary phase support. The technology has additional advantages over traditional HIC materials, which often require bonding two dissimilar monomers to the stationary phase support to achieve a desired hydrophobicity. However, in the HIC stationary phase of the technology described herein, only one type of monomer is required to be attached to the stationary phase support. This is more easily and more reproducibly controlled by using a one-step hydrophilic binding process instead of a dual step bonding method.

Another advantage of the technology is that relatively small particles can be used (e.g., ˜1-2 μm), which can provide better separation and higher throughput (e.g., superior mass transfer properties) than larger prior art HIC media particles. The technology provides for HIC techniques which can operate at higher pressures (e.g., greater than 5,000 psi) and which enjoy the associated higher flow rates (e.g., to speed separation/analysis). Accordingly, the technology provides for additional or increased efficiency and resolution when compared to the prior art.

In one aspect, the technology features a method for performing hydrophobic interaction chromatography. The method includes providing at least one wall defining a chamber having an inlet and an exit and a stationary phase is disposed within the chamber. The stationary phase comprises particles or monolith represented by Formula 1:

[X]-Q Formula 1

X comprises a hydrophobic surface and Q comprises a hydrophilic ligand. A sample is loaded onto the stationary phase in the chamber and the sample is flowed over the stationary phase. The sample is separated into one or more compositions by hydrophobic interaction between the stationary phase and the one or more compositions.

In another aspect, the technology features a separation method. The method includes providing a stationary phase comprising particles or monolith represented by Formula 1. X comprises a hydrophobic surface and Q comprises a hydrophilic ligand. The method includes contacting a sample with the stationary phase and a mobile phase. The sample is separated into one or more compositions by hydrophobic interaction between the stationary phase, mobile phase, and the one or more compositions.

In yet another aspect, the technology features a separation method including providing a solid stationary phase comprising a hydrophobic surface and a plurality of hydrophilic ligands attached thereto. The method also includes contacting a liquid sample and the solid stationary phase. The liquid sample potentially comprises one or more analytes. The one or more analytes, if present, are separated through hydrophobic interaction between the one or more analytes, the stationary phase and the mobile phase.

In another aspect, the technology features, a hydrophobic interaction chromatography method including providing a solid stationary phase comprising ethylene bridged hybrid (BEH) particles having a hydrophobic surface and a plurality of diol ligands attached thereto. The method also includes contacting a liquid sample and the solid stationary phase. The liquid sample potentially comprises one or more protein analytes. The method includes separating the one or more protein analytes, if present, through hydrophobic interaction between the one or more protein analytes and the stationary phase.

In yet another aspect, the technology features a kit for hydrophobic interaction chromatography. The kit includes a solid stationary phase comprising a hydrophobic surface and a plurality of hydrophilic ligands attached thereto. The kit also includes instructions for (i) contacting a liquid sample and the solid stationary phase, wherein the liquid sample potentially comprises one or more analytes and (ii) separating the one or more analytes, if present, from the sample through hydrophobic interaction between the one or more analytes and the stationary phase.

In some embodiments, the step of flowing the sample over the stationary phase is carried out at an inlet pressure greater than 1,000 psi. The step of flowing the sample over the stationary phase can be carried out at an inlet pressure greater than 5,000 psi. The step of flowing the sample over the stationary phase can be carried out at an inlet pressure greater than 7,000 psi. In some embodiments, flowing the sample over the stationary phase is carried out at an inlet pressure greater than 10,000 psi.

The method can also include the step of isolating the one or more compositions. In some embodiments, the method also includes detecting the one or more compositions.

The sample can include one or more biopolymers.

In some embodiments, the hydrophobic surface includes a hydrophobic monolayer.

In some embodiments, X (of Formula 1) comprises a hydrophobic core. For example, X can include an organic-inorganic hybrid core comprising an aliphatic bridged silane. In some embodiments, the aliphatic bridged silane is ethylene bridged silane.

In other embodiments, X (of Formula 1) comprises a composite material, which has an inner core and an outer coating. The outer coating is hydrophobic and the inner core can be a hydrophilic material, such as silica, titanium oxide, or aluminum oxide.

In some embodiments, Q (of Formula 1) is an aliphatic group. The aliphatic group can be an aliphatic hydroxyl group. In some embodiments, the aliphatic hydroxyl group is a diol.

The method can also include using a hydrophobic interaction chromatography solvent system to separate the one or more analytes from the sample through hydrophobic interaction chromatography. The solvent system can include an aqueous buffer. In some embodiments, the solvent system includes a salt gradient.

The solid stationary phase can include ethylene bridged hybrid (BEH) particles. In some embodiments, the solid stationary phase includes particles having a mean size between about 1 and 2 microns. The solid stationary phase can include particles having a mean size between about 2 and 25 microns. The solid stationary phase can include particles having a mean size between about 25 and 50 microns. The solid stationary phase can include particles having a mean size between about 7 and 10 microns.

In some embodiments, the solid stationary phase includes porous particles. The solid stationary phase can include nonporous particles. The solid stationary phase can include a monolith. In some embodiments, the solid stationary phase includes chromatographic fibers. The solid stationary phase can include magnetic particles having hydrophobic surfaces. In some embodiments, the magnetic particles have hydrophilic surfaces which are then coated with a hydrophobic layer.

In some embodiments, the ligands can each comprise an alcohol. The ligands can each comprise a diol. The ligands can each comprise an ether. The ligands can each comprise an amide. The ligands consist essentially of a single type of ligand.

In some embodiments, the hydrophobic surface includes a coating on the solid stationary phase. The hydrophobic surface can be integral with the solid stationary phase.

In some embodiments, the solid stationary phase includes ethylene bridged hybrid (BEH) particles having a hydrophobic surface and a plurality of diol ligands attached thereto.

In some embodiments, the sample includes one or more biopolymers.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIG. 1 is a schematic illustration of a prior art stationary phase for HIC.

FIG. 2 is a schematic illustration of a stationary phase for HIC in accordance with an illustrative embodiment of the technology.

FIG. 3 is a schematic illustration of a stationary phase for HIC in accordance with an illustrative embodiment of the technology.

FIG. 4 is a schematic illustration of a device in accordance with an illustrative embodiment of the technology.

FIG. 5a is a chromatogram of proteins separated using a stationary phase for HIC in accordance with an illustrative embodiment of the technology.

FIG. 5b is a chromatogram of proteins separated using a commercially available column.

FIG. 5c is a chromatogram of proteins separated using a commercially available column with different dimensions than FIG. 5b.

FIG. 6 is a chromatogram of proteins separated using a stationary phase for HIC in accordance with an illustrative embodiment of the technology.

FIG. 7 is chromatogram of a step gradient in accordance with an illustrative embodiment of the technology.

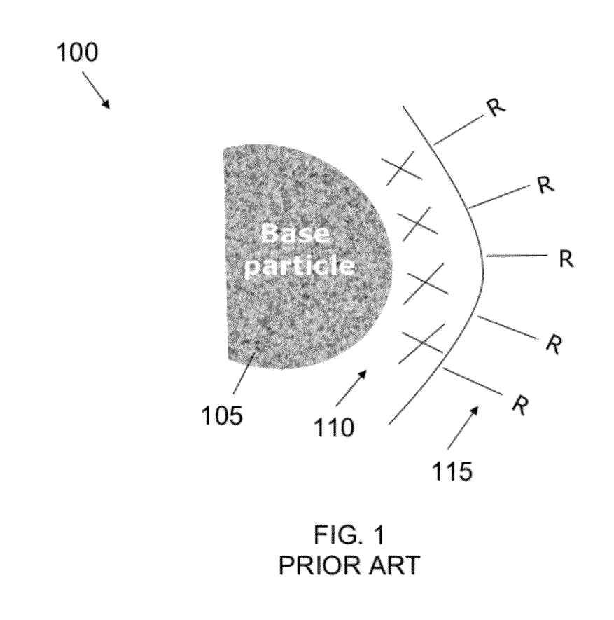

### DETAILED DESCRIPTION

The devices and methods of the technology utilize stationary phases that comprise particles with a hydrophobic surface and a plurality of hydrophilic ligands attached thereto in HIC. Such materials can be, for example, in the form of a monolith, one or more particles, one or more spherical particles, or one or more pellicular particles (e.g., a particle having a thin skin or film or porous shell on the outer surface of the particle), which are described in further detail below. The devices and methods of the technology can be implemented using a variety of chemical moieties, examples of which are described in the following definitions.

As used herein, the term “aliphatic group” includes organic compounds characterized by straight or branched chains, typically having between 1 and 22 carbon atoms. Aliphatic groups include alkyl groups, alkenyl groups and alkynyl groups. In complex structures, the chains can be branched or cross-linked. Alkyl groups include saturated hydrocarbons having one or more carbon atoms, including straight-chain alkyl groups and branched-chain alkyl groups. Such hydrocarbon moieties can be substituted on one or more carbons with, for example, a halogen, a hydroxyl, a thiol, an amino, an alkoxy, an alkylcarboxy, an alkylthio, or a nitro group. Unless the number of carbons is otherwise specified, “lower aliphatic” as used herein means an aliphatic group, as defined above (e.g., lower alkyl, lower alkenyl, lower alkynyl), but having from one to six carbon atoms. Representative of such lower aliphatic groups, e.g., lower alkyl groups, are methyl, ethyl, n-propyl, isopropyl, 2-chloropropyl, n-butyl, sec-butyl, 2-aminobutyl, isobutyl, tert-butyl, 3-thiopentyl and the like. As used herein, the term “nitro” means —NO₂; the term “halogen” designates —F, —Cl, —Br or —I; the term “thiol” means SH; and the term “hydroxyl” means —OH. Thus, the term “alkylamino” as used herein means an alkyl group, as defined above, having an amino group attached thereto. Suitable alkylamino groups include groups having 1 to about 12 carbon atoms, or from 1 to about 6 carbon atoms. The term “alkylthio” refers to an alkyl group, as defined above, having a sulfhydryl group attached thereto. Suitable alkylthio groups include groups having 1 to about 12 carbon atoms, or from 1 to about 6 carbon atoms. The term “alkylcarboxyl” as used herein means an alkyl group, as defined above, having a carboxyl group attached thereto. The term “alkoxy” as used herein means an alkyl group, as defined above, having an oxygen atom attached thereto. Representative alkoxy groups include groups having 1 to about 12 carbon atoms, or 1 to about 6 carbon atoms, e.g., methoxy, ethoxy, propoxy, tert-butoxy and the like. The terms “alkenyl” and “alkynyl” refer to unsaturated aliphatic groups analogous to alkyls, but which contain at least one double or triple bond respectively. Suitable alkenyl and alkynyl groups include groups having 2 to about 12 carbon atoms, or from 1 to about 6 carbon atoms.

The term “aromatic group” includes unsaturated cyclic hydrocarbons containing one or more rings. Aromatic groups include 5- and 6-membered single-ring groups which may include from zero to four heteroatoms, for example, benzene, pyrrole, furan, thiophene, imidazole, oxazole, thiazole, triazole, pyrazole, pyridine, pyrazine, pyridazine and pyrimidine and the like. The aromatic ring may be substituted at one or more ring positions with, for example, a halogen, a lower alkyl, a lower alkenyl, a lower alkoxy, a lower alkylthio, a lower alkylamino, a lower alkylcarboxyl, a nitro, a hydroxyl, —CF₃, —CN, or the like.

The term “alkyl” includes saturated aliphatic groups, including straight-chain alkyl groups, branched-chain alkyl groups, cycloalkyl (alicyclic) groups, alkyl substituted cycloalkyl groups and cycloalkyl substituted alkyl groups. In certain embodiments, a straight chain or branched chain alkyl has 30 or fewer carbon atoms in its backbone, e.g., C₁-C₃₀ for straight chain or C₃-C₃₀ for branched chain. In certain embodiments, a straight chain or branched chain alkyl has 20 or fewer carbon atoms in its backbone, e.g., C₁-C₂₀ for straight chain or C₃-C₂₀ for branched chain, and in some embodiments 18 or fewer. Likewise, particular cycloalkyls have from 4-10 carbon atoms in their ring structure and in some embodiments have 4-7 carbon atoms in the ring structure. The term “lower alkyl” refers to alkyl groups having from 1 to 6 carbons in the chain and to cycloalkyls having from 3 to 6 carbons in the ring structure.

Moreover, the term “alkyl” (including “lower alkyl”) as used throughout the specification and claims includes both “unsubstituted alkyls” and “substituted alkyls”, the latter of which refers to alkyl moieties having substituents replacing a hydrogen on one or more carbons of the hydrocarbon backbone. Such substituents can include, for example, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, or an aromatic or heteroaromatic moiety. It will be understood by those skilled in the art that the moieties substituted on the hydrocarbon chain can themselves be substituted, if appropriate. Cycloalkyls can be further substituted, e.g., with the substituents described above. An “aralkyl” moiety is an alkyl substituted with an aryl, e.g., having 1 to 3 separate or fused rings and from 6 to about 18 carbon ring atoms, e.g., phenylmethyl (benzyl).

The term “aryl” includes 5- and 6-membered single-ring aromatic groups that can include from zero to four heteroatoms, for example, unsubstituted or substituted benzene, pyrrole, furan, thiophene, imidazole, oxazole, thiazole, triazole, pyrazole, pyridine, pyrazine, pyridazine and pyrimidine and the like. Aryl groups also include polycyclic fused aromatic groups such as naphthyl, quinolyl, indolyl and the like. The aromatic ring can be substituted at one or more ring positions with such substituents, e.g., as described above for alkyl groups. Suitable aryl groups include unsubstituted and substituted phenyl groups. The term “aryloxy” as used herein means an aryl group, as defined above, having an oxygen atom attached thereto.

The term “aralkoxy” as used herein means an aralkyl group, as defined above, having an oxygen atom attached thereto. Suitable aralkoxy groups have 1 to 3 separate or fused rings and from 6 to about 18 carbon ring atoms, e.g., O-benzyl.

The term “amino,” as used herein, refers to an unsubstituted or substituted moiety of the formula —NRₐR_{b}, in which Rₐ and R_{b} are each independently hydrogen, alkyl, aryl, or heterocyclyl, or Rₐ and R_{b}, taken together with the nitrogen atom to which they are attached, form a cyclic moiety having from 3 to 8 atoms in the ring. Thus, the term “amino” includes cyclic amino moieties such as piperidinyl or pyrrolidinyl groups, unless otherwise stated. An “amino-substituted amino group” refers to an amino group in which at least one of Rₐ and R_{b}, is further substituted with an amino group.

“Hybrid”, including “organic-inorganic hybrid material,” includes inorganic-based structures wherein an organic functionality is integral to both the internal or “skeletal” inorganic structure as well as the hybrid material surface. The inorganic portion of the hybrid material can be, e.g., alumina, silica, titanium, cerium, or zirconium or oxides thereof, or ceramic material. “Hybrid” includes inorganic-based structures wherein an organic functionality is integral to both the internal or “skeletal” inorganic structure as well as the hybrid material surface. As noted above, exemplary hybrid materials are shown in U.S. Pat. Nos. 4,017,528, 6,528,167, 6,686,035 and 7,175,913.

The term “BEH,” as used herein, refers to an organic-inorganic hybrid material which is an ethylene bridged hybrid material.

The term “functionalizing group” or “functionalizable group” includes organic functional groups which impart a certain chromatographic functionality to a stationary phase.

The term “terminal group,” as used herein, represents a group which cannot undergo further reactions. In certain embodiments, a terminal group may be a hydrophilic terminal group. Hydrophilic terminal groups include, but are not limited to, protected or deprotected forms of an alcohol, diol, glycidyl ether, epoxy, triol, polyol, pentaerythritol, pentaerythritol ethoxylate, 1,3-dioxane-5,5-dimethanol, tris(hydroxymethyl)aminomethane, tris(hydroxymethyl)aminomethane polyglycol ether, ethylene glycol, propylene glycol, poly(ethylene glycol), poly(propylene glycol), a mono-valent, divalent, or polyvalent carbohydrate group, a multi-antennary carbohydrate, a dendrimer containing peripheral hydrophilic groups, a dendrigraph containing peripheral hydrophilic groups, or a zwitterion group.

### Stationary Phases

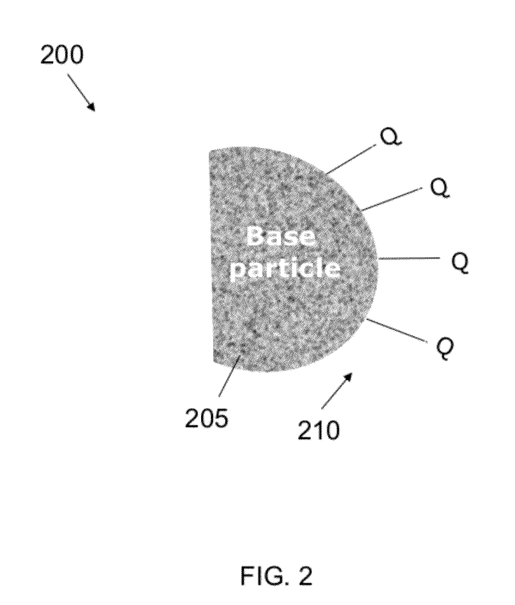

FIG. 2 shows an example stationary phase 200 for use in HIC. In some embodiments, the stationary phase comprises particles (or, alternatively, monolith) represented by:

[X]Q Formula 1

wherein X comprises a hydrophobic surface of a base particle 205 and Q comprises a hydrophilic ligand 210. In contrast to the prior art stationary phases used for HIC, a solid stationary phase of the technology comprises a hydrophobic surface 205 and a plurality of hydrophilic ligands 210 attached thereto. The ligands can consist essentially of a single type of ligand. In some embodiments, the hydrophobic surface includes a coating on the solid stationary phase. The hydrophobic surface can be integral with the solid stationary phase.

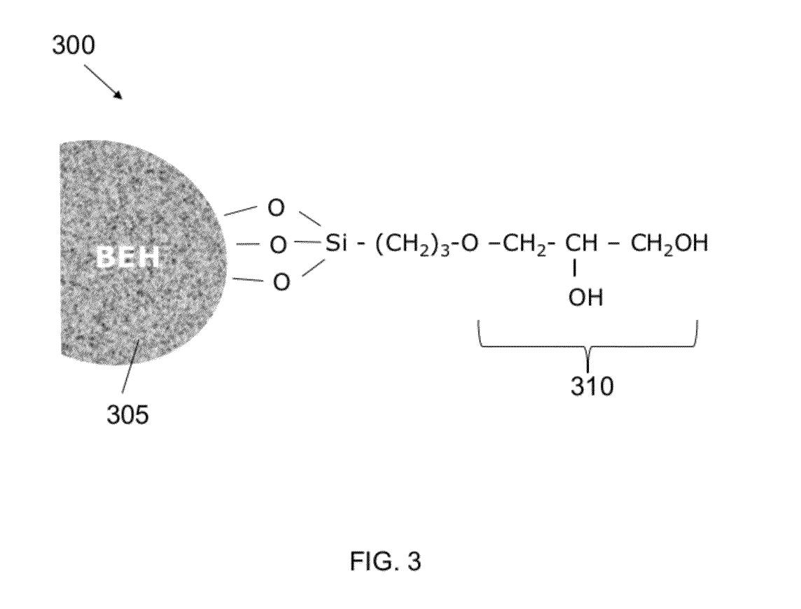

FIG. 3 shows one specific example of a stationary phase 300 for use in HIC having a hydrophobic BEH base particle 305 and a hydrophilic layer 310. Based upon the detailed description herein, other variations will be apparent to a person of ordinary skill in the art.

In aspects of the invention when the stationary phase is particulate, the particles of the particulate stationary phase may have diameters with a mean size distribution of about 1 and 2 microns. In some embodiments, the solid stationary phase includes particles having a mean size between about 2 and 25 microns. In embodiments, the solid stationary phase can include particles having a mean size between about 25 and 50 microns. In other embodiments, the solid stationary phase can include particles having a mean size between about 7 and 10 microns.

In other embodiments of the device of the invention, the stationary phase comprises a monolith. In embodiments of the device of the invention wherein the stationary phase comprises monolith, the monolith of the stationary phase exhibits chromatographic efficiency that is comparable to a packed bed of particles having a given particle size (e.g., a mean size distribution of 1.0-50.0 microns), and with a permeability of a packed bed of particles of a size larger (e.g., 2×, 4×, etc.) than the given particle size. In other embodiments of the device of the invention, the stationary phase has a pore volume of 0.8 to 1.7 cm³/g; 0.9 to 1.6 cm³/g; 1.0 to 1.5 cm³/g′ or 1.1 to 1.5 cm³/g. In some embodiments, the mean pore size is 100 Å, 200 Å, 300 Å, 500 Å, 750 Å, 1000 Å, or 1500 Å.

In some embodiments, X (of Formula 1) comprises a hydrophobic core. X can include an organic-inorganic hybrid core comprising an aliphatic bridged silane. In some embodiments, the aliphatic bridged silane is ethylene bridged silane. In certain embodiments, X (of Formula 1) comprises a composite material, which has an inner core and an outer coating. The outer coating is hydrophobic and the inner core can be a hydrophilic. Examples of hydrophilic inner core materials, include, but are not limited to, silica, titanium oxide, aluminum oxide, and iron oxide. In some embodiments, the hydrophobic coating material can be adapted for use in combination with one or more of silica, titanium oxide or aluminum oxide. For example, the coating can be hydrophobic and reactive, e.g., a BEH coating. In another example, the coating can be a polymer with a reactive group such as a vinyl group, e.g., DVB.

In certain other embodiments, the core material, X, may be cerium oxide, zirconium oxides, or a ceramic material. In certain other embodiments, the core material, X, may have chromatographically enhancing pore geometry (CEPG). CEPG includes the geometry that has been found to enhance the chromatographic separation ability of the material, e.g., as distinguished from other chromatographic media in the art. For example, a geometry can be formed, selected or constructed, and various properties and/or factors can be used to determine whether the chromatographic separations ability of the material has been “enhanced”, e.g., as compared to a geometry known or conventionally used in the art. Examples of these factors include high separation efficiency, longer column life and high mass transfer properties (as evidenced by, e.g., reduced band spreading and good peak shape.) These properties can be measured or observed using art-recognized techniques. For example, the chromatographically-enhancing pore geometry of the present porous inorganic/organic hybrid particles is distinguished from the prior art particles by the absence of “ink bottle” or “shell shaped” pore geometry or morphology, both of which are undesirable because they, e.g., reduce mass transfer rates, leading to lower efficiencies.

Chromatographically-enhancing pore geometry can be found, for example, in hybrid materials containing only a small population of micropores. A small population of micropores can be achieved in hybrid materials when essentially all pores of a diameter of about <34 Å contribute less than about 110 m²/g to the specific surface area of the material. Hybrid materials with such a low micropore surface area (MSA) can give chromatographic enhancements including, for example, high separation efficiency and good mass transfer properties (as evidenced by, e.g., reduced band spreading and good peak shape). Micropore surface area (MSA) can be defined as the surface area in pores with diameters less than or equal to 34 Å, determined by multipoint nitrogen sorption analysis from the adsorption leg of the isotherm using the BJH method. As used herein, the acronyms “MSA” and “MPA” are used interchangeably to denote “micropore surface area”.

In certain embodiments the core material, X, can include surface modified with a surface modifier having the formula Zₐ(R′)_{b}Si—R″, where Z=Cl, Br, I, or C₁-C₅ alkoxy; a and b are each an integer from 0 to 3 provided that a+b=3; R′ is a C₁-C₆ straight, cyclic or branched alkyl group, and R″ is a functionalizing group. In some embodiments, Z is dialkylamino or trifluoromethanesulfonate. In another embodiment, the core material, X, can include surface modified by coating with a polymer. In some embodiments, the surface modifier is selected from the group consisting of an isocyanate or 1,1′-carbonyldiimidazole (particularly when the hybrid group contains a (CH₂)₃OH group).

In another embodiment, the material has been surface modified by a combination of organic group and silanol group modification. In still another embodiment, the material has been surface modified by a combination of organic group modification and coating with a polymer. In a further embodiment, the organic group comprises a chiral moiety. In yet another embodiment, the material has been surface modified by a combination of silanol group modification and coating with a polymer.

In other embodiments, the material has been surface modified via formation of an organic covalent bond between an organic group on the material and the modifying reagent. In still other embodiments, the material has been surface modified by a combination of organic group modification, silanol group modification and coating with a polymer. In another embodiment, the material has been surface modified by silanol group modification.

In some embodiments of the stationary phase, Q can be an aliphatic diol. In still other embodiments, Q is represented by Formula 2:

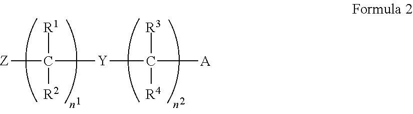

wherein

n an integer from 0-30;

n² an integer from 0-30;

each occurrence of R¹, R², R³ and R⁴ independently represents hydrogen, a protected or deprotected alcohol, a zwiterion, or a group Z;

Z represents:
a) a surface attachment group produced by formation of covalent or non-covalent bond between the surface of the stationary phase material with a moiety of Formula 3:

(B¹)ₓ(R⁵)_{y}(R⁶)_{z}Si— Formula 3:

wherein x is an integer from 1-3, y is an integer from 0-2, z is an integer from 0-2, and x+y+z=3,
each occurrence of R⁵ and R⁶ independently represents methyl, ethyl, n-butyl, iso-butyl, tert-butyl, iso-propyl, thexyl, substituted or unsubstituted aryl, cyclic alkyl, branched alkyl, lower alkyl, a protected or deprotected alcohol, or a zwiterion group;
B¹ represents —OR′, —NR^{7′}R^{7″}, —OSO₂CF₃, or —Cl; where each of R⁷, R^{7′} and R^{7″} represents hydrogen, methyl, ethyl, n-butyl, iso-butyl, tert-butyl, iso-propyl, thexyl, phenyl, branched alkyl or lower alkyl;
b) a direct attachment to a surface hybrid group of X through a direct carbon-carbon bond formation or through a heteroatom, ester, ether, thioether, amine, amide, imide, urea, carbonate, carbamate, heterocycle, triazole, or urethane linkage; or
c) an adsorbed group that is not covalently attached to the surface of the stationary phase;
d) a surface attachment group produced by formation of a covalent bond between the surface of the stationary phase by reaction with a vinyl or alkynyl group;
Y represents a direct bond; a heteroatom linkage; an ester linkage; an ether linkage; a thioether linkage; an amine linkage; an amide linkage; an imide linkage; a urea linkage; a thiourea linkage; a carbonate linkage; a carbamate linkage; a heterocycle linkage; a triazole linkage; a urethane linkage; a diol linkage; a polyol linkage; an oligomer of styrene, ethylene glycol, or propylene glycol; a polymer of styrene, ethylene glycol, or propylene glycol; a carbohydrate group, a multi-antennary carbohydrates, a dendrimer or dendrigraphs, or a zwitterion group; and
A represents a hydrophilic terminal group.

In certain embodiments of the device of the invention, wherein Q is an aliphatic diol of Formula 2, n¹ an integer from 2-18, or from 2-6. In other embodiments of the device of the invention, wherein Q is an aliphatic diol of Formula 2, n² an integer from 0-18 or from 0-6. In still other embodiments of the device of the invention, wherein Q is an aliphatic diol of Formula 2, n¹ an integer from 2-18 and n² an integer from 0-18, n¹ an integer from 2-6 and wherein n² an integer from 0-18, n¹ an integer from 2-18 and n² an integer from 0-6, or n¹ an integer from 2-6 and n² an integer from 0-6.

In yet other embodiments of the stationary phase, wherein Q is an aliphatic diol of Formula 2, A represents i) a hydrophilic terminal group and said hydrophilic terminal group is a protected or deprotected forms of an alcohol, diol, glycidyl ether, epoxy, triol, polyol, pentaerythritol, pentaerythritol ethoxylate, 1,3-dioxane-5,5-dimethanol, tris(hydroxymethyl)aminomethane, tris(hydroxymethyl)aminomethane polyglycol ether, ethylene glycol, propylene glycol, poly(ethylene glycol), poly(propylene glycol), a mono-valent, divalent, or polyvalent carbohydrate group, a multi-antennary carbohydrate, a dendrimer containing peripheral hydrophilic groups, a dendrigraph containing peripheral hydrophilic groups, or a zwitterion group.

In still yet other embodiments of the stationary phase, wherein Q is an aliphatic diol of Formula 2, A represents ii) a functionalizable group, and said functionalizable group is a protected or deprotected form of an amine, alcohol, silane, alkene, thiol, azide, or alkyne. In some embodiments, said functionalizable group can give rise to a new surface group in a subsequent reaction step wherein said reaction step is coupling, metathesis, radical addition, hydrosilylation, condensation, click, or polymerization.

One advantage of the HIC media of the technology (e.g., as shown in FIGS. 2 and 3) lies in the balance between the hydrophilic coating and the hydrophobic base particle—unlike the prior art, the technology does not require the amount of surface hydrophobicity to be carefully controlled by the difficult process of reproducibly bonding small amounts of hydrophobic functional groups to the stationary phase support. The technology has additional advantages over traditional HIC materials, which often require bonding two dissimilar monomers to the stationary phase support to achieve a desired hydrophobicity. However, in the HIC stationary phase of the technology described herein, only one type of monomer is required to be attached to the stationary phase support. This is more easily and more reproducibly controlled by using a one-step hydrophilic binding process instead of a dual step bonding method. (See for example, Particle Synthesis section below, the processes described in Examples 4 and 5.)

Another advantage of the technology is that relatively small particles can be used (e.g., ˜1-2 μm), which can provide better separation and higher throughput (e.g., superior mass transfer properties) than larger prior art HIC media particles. The technology provides for HIC techniques which can operate at high pressures (e.g., greater than 5,000 psi) and which enjoy the associated flow rates (e.g., to speed separation/analysis). Accordingly, the technology provides for additional or increased efficiency and resolutions, reduced solvent usage, and improved compatibility with advanced detectors when compared to the prior art.

While the HIC stationary phase has been described herein in the context of traditional chromatographic material formats, it can also be implemented in other media for liquid-phase separations such as magnetic beads and coated filtration fibers.

### Chromatography System

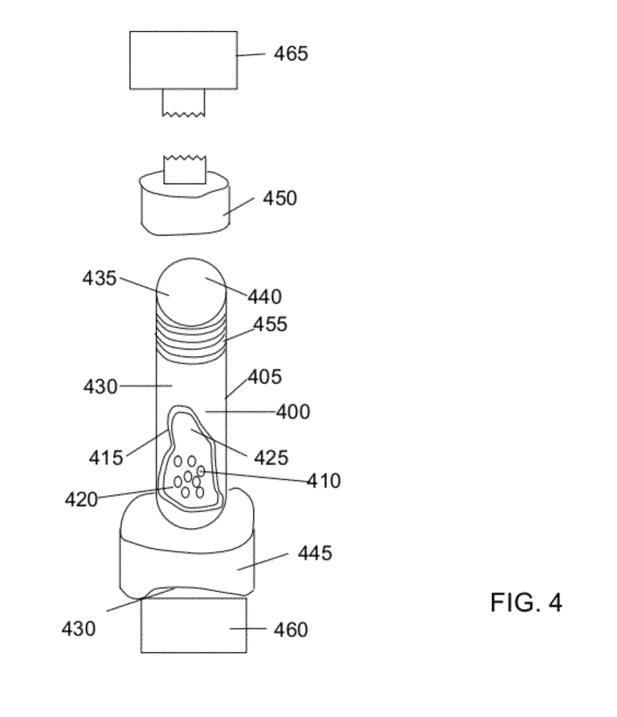

The HIC stationary phases of the technology (e.g., material 200 of FIGS. 2 and 300 of FIG. 3) can be used in a column in connection with the separation and analysis of a sample. FIG. 4 shows an example device 400 embodying features of the present technology. HIC device 400 comprises a housing 405 and a stationary phase 410 contained therein.

The housing 405 has at least one wall 415 defining a chamber 420. As depicted, the wall 415 is in the form of a cylinder having an interior surface 425 and an exterior surface 430. Although described herein as a column, the housing 405 and the wall 415 defining a chamber 420 can assume any shape. For example, and without limitation, the housing 405 can be a planar chip-like structure in which the chamber 420 is formed within.

As depicted, the at least one wall 415 defines a chamber having an entrance opening 430 and an exit opening 435. Although the entrance opening 430 is obscured in FIG. 4, the entrance opening 430 and the exit opening 435 can share several features. The entrance opening 430 and/or the exit opening 435 can have a frit of which only frit 440 is shown with respect to exit opening 435. In some embodiments, only one opening 430, 435 has a frit 440, for example, only the exit opening 435 has a frit 440. In other embodiments, both openings 430 and 435 each have their own frit 440. As depicted, the frit 440 is an element which contains the stationary phase within the column, but allows mobile phase to pass through. In certain embodiments, the frit can be comprised of sintered metal or similar material. In other embodiments, the frit can also be comprised of a binder or glue that holds the particles in the bed together, but is porous enough to allow fluid to flow through the bed. In still other embodiments, the stationary phase can be a porous monolith. In such embodiments, a frit element may not be required.

The at least one wall 415 has a first connection means at or about the entrance opening 430 and a second connection means at or about the exit opening 435. The first connection means comprises a fitting nut 445 held to the at least one wall 415 by cooperating threads (not shown). Similarly, the second connection means comprises a second fitting nut 450 held to the at least one wall 415 by cooperating threads 455. First and second connection means can comprise cooperating fittings, clamps, interlocking grooves and the like (not shown). First connection means and second connection means can also comprise ferrules, seals, O-rings, and the like (not shown) which have been omitted from the drawing for clarity.

The entrance opening 430 of chamber 420 is in fluid communication with a source of fluid and sample depicted in block schematic form by numeral 460. One preferred source of fluid and sample has an operating pressure in the normal HIC range of about 5,000 psi. However, particles and the device 400 are capable of operating at various pressures, for example, pressures of greater than 1,000 psi; greater than 2,000 psi; greater than 3,000 psi; greater than 4,000 psi; greater than 5,000 psi; greater than 6,000 psi; greater than 7,000 psi; greater than 8,000 psi; greater than 9,000 psi; or greater than 10,000 psi. In still other embodiments of the device of the technology, particles and the device 400 are capable of operating pressures from about 1,000 psi to about 15,000 psi; from about 5,000 psi to about 15,000 psi; from about 7,000 psi to about 15,000 psi; from about 10,000 psi to about 15,000 psi; about 1,000 psi to about 10,000 psi; or from about 5,000 to about 10,000 psi.

In certain specific embodiments, the source of fluid and sample is a separation module such as an ACQUITY® UPLC® separation module (Waters Corporation, Milford, Mass., USA).

The exit opening 435 of chamber 420 is in fluid communication with a detector 465. One example is a Waters ACQUITY® UPLC® Tunable UV Detector (Waters Corporation, Milford, Mass., USA).

Particulate stationary phase media 410 is held in the chamber 420. The particulate stationary phase media 410 comprises particles, which are not drawn to scale in FIG. 4. The particles are generally spheres but can be any shape useful in chromatography. The particles generally have a size distribution of about ±0.5 in which the average diameter is 1-3 microns.

### Housing, Detectors, and Sample Injection Devices

In some devices according to the technology, the housing is equipped with one or more frits to contain the stationary phase. In embodiments in which the stationary phase is a monolith, the housing can be used without the inclusion of one or more frits.

In other embodiments, the housing is equipped with one or more fittings capable of placing the device in fluid communication with a sample injection device, a detector or both.

An example of a detector used for HIC is a UV detector. Other types of detectors can also be used.

Examples of injection devices include, without being limited thereto, on-column injectors, split injectors, and splitless injectors.

### Methods of Performing Hydrophobic Interaction Chromatography

The technology includes methods for performing hydrophobic interaction chromatography using the materials and systems described herein. In general, the methods include providing a solid stationary phase comprising a hydrophobic surface and a plurality of hydrophilic ligands attached thereto, contacting a liquid sample that potentially comprises one or more analytes and the solid stationary phase. The one or more analytes, if present, are separated through hydrophobic interaction between the one or more analytes and the stationary phase.

In another embodiment, the HIC method includes providing at least one wall defining a chamber having an inlet and an exit, and a stationary phase is disposed within the chamber. The stationary phase comprises particles or monolith represented by Formula 1:

[X]-Q Formula 1

X comprises a hydrophobic surface and Q comprises a hydrophilic ligand. A sample is loaded onto the stationary phase in the chamber and the sample is flowed over the stationary phase. The sample is separated into one or more compositions by hydrophobic interaction between the stationary phase and the one or more compositions.

In yet another embodiment, the HIC method includes providing a stationary phase comprising particles or monolith represented by Formula 1. X comprises a hydrophobic surface and Q comprises a hydrophilic ligand. The method includes contacting a sample, the stationary phase, and the mobile phase. The sample is separated into one or more compositions by hydrophobic interaction between the stationary phase and the one or more compositions.

The method can also include the step of isolating the one or more compositions. In some embodiments, the method also includes detecting the one or more compositions. The sample/composition can include one or more biopolymers (e.g., amino acid, nucleic acids, and the like).

In general, the method can use a hydrophobic interaction chromatography solvent system to separate the one or more analytes/compositions from the sample through hydrophobic interaction chromatography. The solvent system can include an aqueous buffer. In some embodiments, the solvent system includes a salt gradient. The gradient begins with high concentration of salt to promote hydrophobic interaction between the analyte and the stationary phase, and ends with low concentration of salt to elute out the analyte. The type of salt can be selected based on its “salting out” effect and the hydrophobicity of the particular stationary phase and analyte used.

### Hydrophobic Interaction Chromatography Kits

The technology includes kits for performing hydrophobic interaction chromatography using the materials and systems described herein. In general, the kits include a solid stationary phase comprising a hydrophobic surface and a plurality of hydrophilic ligands attached thereto. The kit also includes instructions for (i) contacting a liquid sample and the solid stationary phase, wherein the liquid sample potentially comprises one or more analytes and (ii) separating the one or more analytes, if present, from the sample through hydrophobic interaction between the one or more analytes and the stationary phase.

In various embodiments, kits can include any one or more of the aspects of the technology. For example, a kit can include any one or more of a solid stationary phase, a solvent system, a column, and the like. A kit can also include further instructions for practicing the technology, for example, with regard to preparing a stationary phase, selecting a stationary phase, selecting a mobile phase, and/or carrying out an analysis of a sample/composition. The kit can include instructions for any of the methods described in detail above. The kit can include different instructions that can be used based on the specific separation to be performed by the end user. For example, the instructions can be specific to a particular analyte or panel of analytes.

### EXAMPLES

The present technology can be further illustrated by the following non-limiting examples describing the chromatographic devices and methods.

### Materials

All reagents were used as received unless otherwise noted. Those skilled in the art will recognize that equivalents of the following supplies and suppliers exist and, as such, the suppliers listed below are not be construed as limited.

### Characterization

Those skilled in the art will recognize that equivalents of the following instruments and suppliers exist and, as such, the instruments listed below are not to be construed as limiting.

For example, ACQUITY UPLC® system and ACQUITY Binary Solvent Manager, ACQUITY Sample Manager, ACQUITY Column Heater/Cooler, all available from Waters Corporation, Milford, Mass. 01757, USA, can be used or their equivalent in the following examples.

### Particle Synthesis

The particles used in a column in connection with the separation and analysis of a sample can be synthesized in many different ways. The examples provided below are not to be construed as limiting.

### Example 1

An aqueous mixture of Triton® X-100 (X100, Dow Chemical, Midland, Mich.), deionized water and ethanol (EtOH; anhydrous, J. T. Baker, Phillipsburgh, N.J.) was heated at 55° C. for 0.5 h. In a separate flask, an oil phase solution was prepared by mixing a POS prepared as detailed in Example 1 h from U.S. Pat. No. 6,686,035 B2 for 0.5 hours with toluene (Tol; HPLC grade, J. T. Baker, Phillipsburgh, N.J.). Under rapid agitation, the oil phase solution was added into the EtOH/water/X100 mixture and was emulsified in the aqueous phase using a rotor/stator mixer (model 100 L, Charles Ross & Son Co., Hauppauge, N.Y.). Thereafter, 30% ammonium hydroxide (NH₄OH; J. T. Baker, Phillipsburgh, N.J.) was added into the emulsion. Suspended in the solution, the gelled product was transferred to a flask and stirred at 55° C. for 18 h. The resulting spherical, porous, hybrid inorganic/organic particles of the formula {(O_{1.5}SiCH₂CH₂SiO_{1.5})(SiO₂)₄} were collected on 0.5 μm filtration paper and washed successively with water and methanol (HPLC grade, J. T. Baker, Phillipsburgh, N.J.). The products were then dried in a vacuum oven at 80° C. overnight. Specific amounts of starting materials used to prepare these products are listed in Table 3. The % C values, specific surface areas (SSA), specific pore volumes (SPV) and average pore diameters (APD) of these materials are listed in Table 1. Products prepared by this approach were highly spherical free flowing particles, as confirmed by SEM.

The increase in mass ratio of toluene/POS yielded an increase in SPV from 1.07-1.68 cm³/g.

TABLE 1

| | POS | Tol | Water | Ethanol | X100 | NH₄OH | Mass Ratio | | SSA | SPV | APD |
|---|---|---|---|---|---|---|---|---|---|---|---|
| Product | (g) | (g) | (Kg) | (g) | (g) | (mL) | Toluene/POS | % C | (m²/g) | (cm³/g) | (Å) |
| 1a | 290 | 162 | 1.4 | 295 | 28 | 220 | 0.56 | 7.35 | 616 | 1.50 | 94 |
| 1b | 290 | 189 | 1.4 | 295 | 28 | 220 | 0.65 | 7.47 | 597 | 1.68 | 110 |
| 1c | 754 | 270 | 3.64 | 766 | 73 | 572 | 0.36 | 6.72 | 579 | 1.10 | 71 |
| 1d | 754 | 270 | 3.64 | 766 | 73 | 572 | 0.36 | 7.04 | 594 | 1.07 | 67 |
| 1e | 754 | 270 | 3.64 | 766 | 73 | 572 | 0.36 | 7.32 | 593 | 1.17 | 79 |
| 1f | 754 | 270 | 3.64 | 766 | 73 | 572 | 0.36 | 6.92 | 632 | 1.22 | 74 |
| 1g | 754 | 270 | 3.64 | 766 | 73 | 572 | 0.36 | 6.64 | 621 | 1.22 | 73 |
| 1h | 754 | 270 | 3.64 | 766 | 73 | 572 | 0.36 | 7.18 | 619 | 1.10 | 64 |
| 1i | 754 | 270 | 3.64 | 766 | 73 | 572 | 0.36 | 7.52 | 610 | 1.19 | 73 |
| 1j | 38,630 | 13,910 | 186.5 | 41,028 | 13,910 | 29,300 | 0.36 | 7.79 | 581 | 1.36 | 92 |

### Example 2

Porous particles of Examples 1 were sized to generate a 1.5-3.0 micron particle size distributions. Any number of well known sizing techniques may be used. Such sizing techniques are described, for example, in W. Gerhartz, et al. (editors) Ullmann's Encyclopedia of Industrial Chemistry, 5^{th} edition, Volume B2: Unit Operations I, VCH Verlagsgesellschaft mbH, (Weinheim, Fed. Rep. Germ. 1988). These particles were mixed with an aqueous solution of either tris(hydroxymethyl)aminomethane (TRIS; Aldrich, Milwaukee, Wis.) or triethylamine (TEA; Aldrich, Milwaukee, Wis.), yielding a slurry. The pH of the slurry was adjusted as necessary by adding dilute acetic acid. The resultant suspension was then transferred to a stainless steel autoclave and heated to between 120-155° C. for 20-41 hours. Reactions 2a and 2c were performed in glassware. After the autoclave cooled to room temperature the product was isolated on 0.5 μm filtration paper and washed repeatedly using water and methanol (HPLC grade, J. T. Baker, Phillipsburgh, N.J.) and then dried at 80° C. under vacuum for 20 hours.

Specific hydrothermal conditions are listed in Table 2 (mL of base solution/gram of particle, concentration and pH of initial base solutions, reaction temperature, and reaction hold time). The specific surface areas (SSA), specific pore volumes (SPV), average pore diameters (APD), micropore surface area (MSA) and the % C of these materials are listed in Table 2.

TABLE 2

| | | Solid | Solvent | | Conc. | | | | | | | dp₅₀ | | | |
|---|---|---|---|---|---|---|---|---|---|---|---|---|---|---|---|
| | Precur- | Mass | Amount | | (Molar- | | Temp | | SSA | SPV | APD | vol % | ⁹⁰/₁₀ | MPV | MMPD |
| Product | sor | (g) | (mL/g) | Base | ity) | pH | (° C.) | % C | (m²/g) | (cm³/g) | (Å) | (μm) | ratio | (cm³/g) | (Å) |
| 2a | 1j | 15 | 5 | TRIS | 0.3 | 9.8 | 95 | 6.50 | 400 | 1.29 | 114 | 2.83 | 1.56 | 1.19 | 80 |
| 2b | 1j | 15 | 5 | TRIS | 0.3 | 9.8 | 120 | 6.42 | 289 | 1.29 | 151 | 2.27 | 1.50 | 1.19 | 93 |
| 2c | 1j | 30 | 5 | TEA | 0.5 | 12.1 | 80 | 9.15 | 412 | 1.24 | 109 | 2.35 | 1.48 | 1.08 | 95 |
| 2d | 1a | 10 | 10 | TRIS | 0.3 | 9.8 | 145 | 6.38 | 223 | 1.42 | 213 | 2.79 | 1.52 | 1.28 | 131 |
| 2e | 1b | 10 | 10 | TRIS | 0.3 | 9.8 | 152 | 6.35 | 210 | 1.64 | 253 | 2.75 | 1.47 | 1.50 | 142 |
| 2f | 1a | 10 | 10 | TRIS | 0.3 | 9.8 | 160 | 6.39 | 188 | 1.40 | 248 | 2.80 | 1.51 | 1.28 | 169 |
| 2g | 1b | 10 | 10 | TRIS | 0.3 | 9.8 | 160 | 6.36 | 189 | 1.63 | 288 | 2.73 | 1.47 | 1.52 | 162 |
| 2h | 1c, | 10 | 10 | TRIS | 0.3 | 9.7 | 170 | 6.36 | 153 | 1.06 | 236 | 2.90 | 1.53 | 1.03 | 195 |
| | 1d | | | | | | | | | | | | | | |
| 2i | 1c, | 10 | 10 | TRIS | 0.3 | 9.7 | 200 | 6.47 | 94 | 1.02 | 366 | 3.03 | 1.57 | 0.95 | 307 |
| | 1d | | | | | | | | | | | | | | |
| 2j | 1a | 10 | 10 | TRIS | 0.3 | 9.8 | 200 | 6.45 | 115 | 1.42 | 423 | 2.71 | 1.52 | 1.33 | 315 |
| 2k | 1b | 10 | 10 | TRIS | 0.3 | 9.8 | 200 | 6.39 | 117 | 1.63 | 463 | 2.67 | 1.48 | 1.51 | 289 |
| 2l | 1c, | 30 | 10 | TRIS | 0.3 | 9.8 | 200 | 6.44 | 107 | 1.06 | 362 | 2.88 | 1.55 | 0.98 | 282 |
| | 1d | | | | | | | | | | | | | | |
| 2m | 1a | 10 | 10 | TRIS | 0.3 | 9.8 | 200 | 6.42 | 116 | 1.43 | 433 | 2.71 | 1.53 | 1.28 | 317 |
| 2n | 1b | 12 | 10 | TRIS | 0.3 | 9.7 | 200 | 6.43 | 120 | 1.65 | 469 | 2.69 | 1.55 | 1.57 | 275 |
| 2o | 1j | 100 | 10 | TRIS | 0.3 | 9.8 | 147 | 6.37 | 214 | 1.28 | 204 | 1.46 | 1.52 | | |
| 2p | 1j | 100 | 10 | TRIS | 0.3 | 9.8 | 147 | 6.25 | 216 | 1.29 | 205 | 1.50 | 1.50 | | |
| 2q | 1c, | 15.0 | 5 | TEA | 1.0 | 11.6 | 205 | 6.88 | 65 | 1.05 | 610 | 2.79 | 1.56 | 1.00 | 439 |
| | 1d | | | | | | | | | | | | | | |
| 2r | 1e, | 60 | 10 | TRIS | 0.3 | 9.7 | 198 | 6.47 | 108 | 1.13 | 365 | 1.57 | 1.74 | 1.05 | 276 |
| | 1f | | | | | | | | | | | | | | |
| 2s | 1e, | 50 | 10 | TRIS | 0.3 | 9.4 | 200 | 6.50 | 108 | 1.12 | 391 | 1.54 | 1.73 | 0.99 | 282 |
| | 1f | | | | | | | | | | | | | | |
| 2t | 1j | 30 | 5 | TRIS | 0.3 | 10.7 | 109 | 6.48 | 339 | 1.30 | 133 | 2.15 | 1.42 | | |
| 2u | 1j | 50 | 5 | TRIS | 0.3 | 10.6 | 100 | 6.64 | 388 | 1.26 | 115 | 2.26 | 1.45 | | |
| 2v | 1j | 50 | 5 | TRIS | 0.3 | 10.1 | 120 | 6.49 | 300 | 1.27 | 147 | 2.20 | 1.45 | | |
| 2w | 1j | 50 | 5 | TRIS | 0.3 | 9.9 | 109 | 6.52 | 343 | 1.27 | 129 | 2.23 | 1.45 | | |
| 2x | 1j | 50 | 5 | TRIS | 0.3 | 10.0 | 109 | 6.44 | 346 | 1.24 | 128 | 2.06 | 1.39 | | |
| 2y | 1j | 15 | 10 | TEA | 0.5 | 12.0 | 186 | 6.87 | 79 | 1.17 | 555 | 2.06 | 1.51 | 1.18 | 453 |
| 2z | 1j | 60 | 5 | TEA | 0.5 | 11.6 | 186 | 6.92 | 83 | 1.25 | 518 | 2.34 | 1.57 | 1.18 | 419 |
| 2aa | 1j | 10 | 10 | TEA | 0.5 | 11.6 | 186 | 6.7 | 76 | 1.05 | 596 | 2.34 | 1.61 | 1.19 | 472 |
| 2ab | 1j | 10 | 20 | TEA | 0.5 | 11.6 | 186 | 7.07 | 82 | 1.20 | 580 | 2.37 | 1.59 | 1.23 | 454 |
| 2ac | 1j | 100 | 10 | TEA | 0.5 | 11.8 | 186 | 6.62 | 104 | 1.27 | 396 | 1.89 | 1.40 | 1.19 | 334 |
| 2ad | 1j | 15 | 10 | TEA | 0.5 | 11.9 | 186 | 6.88 | 78 | 1.20 | 573 | 1.89 | 1.45 | 1.19 | 456 |
| 2ae | 1j | 2 | 100 | TEA | 0.5 | 11.9 | 186 | 7.37 | 86 | 1.09 | 505 | 2.23 | 1.63 | 1.50 | 433 |
| 2af | 1j | 20 | 5 | TEA | 0.5 | 11.8 | 186 | 6.73 | 83 | 1.15 | 544 | 1.88 | 1.44 | 1.12 | 418 |
| 2ag | 1j | 30 | 10 | TEA | 0.5 | 11.8 | 186 | 6.85 | 80 | 1.18 | 574 | 1.89 | 1.44 | 1.09 | 449 |
| 2ah | 1j | 20 | 17 | TEA | 0.5 | 12.0 | 186 | 7.02 | 79 | 1.23 | 566 | 2.33 | 1.58 | 1.23 | 445 |
| 2ai | 1j | 30 | 10 | TEA | 0.5 | 11.8 | 186 | 6.78 | 81 | 1.22 | 559 | 1.98 | 1.53 | 1.17 | 440 |
| 2aj | 1j | 85 | 10 | TEA | 0.5 | 11.9 | 186 | 6.52 | 110 | 1.23 | 423 | 1.91 | 1.41 | 1.13 | 308 |
| 2ak | 1j | 85 | 10 | TEA | 0.5 | 11.7 | 186 | 6.88 | 81 | 1.20 | 546 | 1.81 | 1.30 | 1.15 | 436 |
| 2al | 1j | 110 | 10 | TEA | 0.5 | 11.6 | 186 | 6.75 | 80 | 1.13 | 559 | 1.47 | 1.46 | 1.05 | 430 |
| 2am | 1j | 30 | 5 | TEA | 0.8 | 12.1 | 186 | 6.84 | 67 | 0.82 | 607 | 1.88 | 1.47 | 1.16 | 529 |
| 2an | 1j | 20 | 10 | TEA | 0.8 | 11.9 | 186 | 6.75 | 68 | 1.04 | 607 | 1.89 | 1.47 | 1.14 | 522 |
| 2ao | 1j | 84 | 5 | TRIS | 0.3 | 9.6 | 147 | 6.55 | 216 | 1.33 | 220 | 1.51 | 1.99 | | |
| 2ap | 1j | 16 | 5 | TRIS | 0.3 | 10.1 | 147 | 6.42 | 198 | 1.19 | 217 | 2.25 | 1.52 | | |
| 2aq | 1j | 60 | 5 | TRIS | 0.3 | 10.7 | 147 | 6.85 | 204 | 1.29 | 212 | 2.65 | 1.87 | | |
| 2ar | 1j | 80 | 5 | TRIS | 0.3 | 9.8 | 100 | 6.55 | 392 | 1.27 | 115 | 1.99 | 1.25 | | |

### Example 3

Porous particles prepared according to Examples 2 were dispersed in a 1 molar hydrochloric acid solution (Aldrich, Milwaukee, Wis.) for 20 h at 98° C. After the acid treatment was completed, the particles were washed with water to a neutral pH, followed by acetone (HPLC grade, J. T. Baker, Phillipsburgh, N.J.). Particles could be further treated by sedimentation in acetone to remove sub-micron fines. The particles were then dried at 80° C. under vacuum for 16 h. Specific characterization data for these materials are listed in Table 3.

TABLE 3

| | | | | | | dp₅₀ | | | |
|---|---|---|---|---|---|---|---|---|---|
| | | | SSA | SPV | APD | vol % | ⁹⁰/₁₀ | MPV | MMPD |
| Product | Precursor | % C | (m²/g) | (cm³/g) | (Å) | (μm) | ratio | (cm³/g) | (Å) |
| 3a | 2i, 2l | 6.41 | 102 | 1.11 | 357 | 2.74 | 1.57 | | |
| 3b | 2q | 6.81 | 68 | — | — | 2.90 | 1.49 | 1.01 | 421 |
| 3c | 2o | 7.01 | 207 | 1.16 | 193 | 1.55 | 1.66 | | |
| 3d | 2o | 6.34 | 204 | 1.26 | 213 | 2.34 | 1.88 | | |
| 3e | 2o | 6.31 | 211 | 1.28 | 207 | 2.20 | 2.32 | | |
| 3f | 2o | 6.40 | 217 | 1.30 | 201 | 1.99 | 1.33 | | |
| 3g | 2o | 6.50 | 215 | 1.28 | 201 | 1.47 | 1.48 | | |
| 3h | 2p | 6.46 | 215 | 1.29 | 201 | 1.53 | 1.48 | | |
| 3i | 2p | 6.40 | 209 | 1.29 | 214 | 1.52 | 1.53 | | |
| 3j | 2p | 6.54 | 214 | 1.29 | 207 | 1.52 | 1.50 | | |
| 3k | 2p | 6.57 | 214 | 1.29 | 205 | 1.5 | 1.55 | | |
| 3l | 2p | 6.61 | 211 | 1.28 | 212 | 1.5 | 1.54 | | |
| 3m | 2r | 6.54 | 112 | 1.12 | 348 | 1.59 | 1.96 | | |
| 3n | 2s | 6.42 | 107 | 1.09 | 373 | 1.61 | 1.83 | 1.00 | 279 |
| 3o | 2d | 6.38 | 225 | 1.42 | 213 | 2.78 | 1.51 | | |
| 3p | 2e | 6.37 | 209 | 1.63 | 259 | 2.48 | 2.01 | | |
| 3q | 2ao | 6.56 | 217 | 1.35 | 214 | 1.52 | 2.01 | | |
| 3r | 2ap | 6.36 | 214 | 1.29 | 215 | 2.24 | 1.48 | | |
| 3s | 2aq | 6.54 | 208 | 1.29 | 217 | 2.28 | 1.66 | | |
| 3t | 2u | 6.71 | 398 | 1.28 | 117 | 2.28 | 1.47 | | |
| 3u | 2v | 6.57 | 307 | 1.29 | 151 | 2.20 | 1.43 | | |
| 3v | 2w | 6.62 | 350 | 1.29 | 132 | 2.20 | 1.43 | | |
| 3w | 2x | 6.30 | 360 | 1.28 | 126 | 2.06 | 1.38 | | |
| 3x | 2ar | 7.11 | 400 | 1.29 | 116 | 1.99 | 1.24 | | |
| 3y | 2z | 6.79 | 85 | 1.24 | 565 | 2.36 | 1.56 | 1.17 | 418 |
| 3z | 2ag, 2ai | 6.77 | 80 | 1.18 | 581 | 1.89 | 1.43 | 1.12 | 438 |
| 3aa | 2al | 6.74 | 82 | 1.16 | 558 | 1.47 | 1.48 | 1.10 | 432 |
| 3ab | 2ak | 6.80 | 81 | 1.20 | 552 | 1.81 | 1.29 | 1.18 | 435 |

### Example 4

Porous particles prepared according to Examples 2 were dispersed in a solution of glycidoxypropyltrimethoxysilane (GLYMO, Aldrich, Milwaukee, Wis.) in a 20 mM acetate buffer (pH 5.5, prepared using acetic acid and sodium acetate, J. T. Baker) that had been premixed at 70° C. for 60 minutes. The mixture was held at 70° C. for 20 hours. The reaction was then cooled and the product was filtered and washed successively with water and methanol (J. T. Baker). The product was then dried at 80° C. under reduced pressure for 16 hours. Reaction data is listed in Table 4. Surface coverages of 5.72-6.09 μmol/m² were determined by the difference in particle % C before and after the surface modification as measured by elemental analysis. Analysis of these materials by ¹³C CP-MAS NMR spectroscopy indicates a mixture of epoxy and diol groups are present for these materials.

TABLE 4

| | | | | | | Surface |
|---|---|---|---|---|---|---|
| | | Hybrid | GLYMO | Dilution | | Coverage |
| Product | Precursor | (g) | (g) | (mL/g) | % C | (μmol/m²) |
| 4a | 3c | 38.0 | 18.59 | 4 | 12.99 | 5.72 |
| 4b | 3d | 2.5 | 1.22 | 8 | 12.65 | 6.06 |
| 4c | 3e | 24.5 | 12.28 | 4 | 12.85 | 6.09 |

### Example 5

Porous particles prepared according to Examples 2 were dispersed in a solution of glycidoxypropyltrimethoxysilane (GLYMO, Aldrich, Milwaukee, Wis.) in an acetate buffer (20 mM, pH 5.5, 5 mL/g dilution, prepared using acetic acid and sodium acetate, J. T. Baker) that had be premixed at 70° C. for 60 minutes. Reaction 5e used a 60 mM buffer solution. The mixture was held at 70° C. for 20 hours. The reaction was then cooled and the product was filtered and washed successively with water and methanol (J. T. Baker). The material was then refluxed in a 0.1 M acetic acid solution (5 mL/g dilution, J. T. Baker) at 70° C. for 20 hours. Product 5q-5s were refluxed for 2 hours. The reaction was then cooled and the product was filtered and washed successively with water and methanol (J. T. Baker). The product was then dried at 80° C. under reduced pressure for 16 hours. Reaction data is listed in Table 5. Surface coverages of 0.55-7.05 μmol/m² were determined by the difference in particle % C before and after the surface modification as measured by elemental analysis. Analysis of these materials by ¹³C CP-MAS NMR spectroscopy indicates for products 5a-5p had no measurable amount of epoxy groups remain, having only diol groups present for these materials. Products 5q-5s had a small amount of epoxy groups present. The acetic acid hydrolysis step was repeated for 5q-5s with a 20 hour hold. The products of these reactions had comparable surface coverage, and had no measurable amount of epoxy groups remaining by ¹³C CP-MAS NMR spectroscopy. Product 5a had a further treatment by heating in 100 mM phosphate buffer (pH 7.0, 10 mL/g dilution) at 70° C. for 2 hours. The resulting material had comparable surface coverage as product 5a.

TABLE 5

| | | | | | Surface |
|---|---|---|---|---|---|
| | | Hybrid | GLYMO | | Coverage |
| Product | Precursor | (g) | (g) | % C | (μmol/m²) |
| 5a | 3e | 24.5 | 12.28 | 12.56 | 6.03 |
| 5b | 3g | 30 | 15.51 | 12.13 | 5.27 |
| 5c | 3g | 30 | 15.51 | 12.13 | 5.27 |
| 5d | 3f | 9 | 4.72 | 12.94 | 6.25 |
| 5e | 3f | 9 | 4.72 | 13.59 | 7.05 |
| 5f | 3h | 30 | 15.65 | 12.08 | 5.25 |
| 5g | 3i | 90 | 45.43 | 11.86 | 5.20 |
| 5h | 3j | 40 | 20.67 | 11.73 | 4.81 |
| 5i | 3j | 20 | 10.34 | 12.83 | 6.07 |
| 5j | 3j | 25 | 12.92 | 12.59 | 5.78 |
| 5k | 3k | 60 | 30.14 | 12.14 | 5.24 |
| 5l | 3k | 60 | 30.14 | 12.17 | 5.27 |
| 5m | 3k | 15 | 7.53 | 12.43 | 5.57 |
| 5n | 3k | 15 | 7.53 | 12.24 | 5.35 |
| 5o | 3k | 15 | 7.75 | 12.48 | 5.63 |
| 5p | 3k | 15 | 7.75 | 12.49 | 5.64 |
| 5q | 3f | 20 | 5.05 | 10.88 | 3.97 |
| 5r | 3f | 20 | 8.98 | 12.01 | 5.18 |
| 5s | 3f | 20 | 11.64 | 12.99 | 6.31 |
| 5t | 3x | 18 | 1.48 | 8.36 | 0.55 |
| 5u | 3x | 18 | 9.82 | 13.90 | 3.65 |
| 5v | 3x | 18 | 15.19 | 14.68 | 4.20 |
| 5w | 3x | 10 | 9.24 | 15.18 | 4.58 |
| 5x | 3o | 6.4 | 3.60 | 12.99 | 6.11 |
| 5y | 3p | 5 | 4.12 | 13.43 | 7.14 |
| 5z | 3q | 73 | 38.42 | 12.55 | 5.64 |
| 5aa | 3r | 10 | 5.17 | 12.75 | 6.15 |
| 5ab | 3y | 27 | 7.40 | 9.01 | 4.71 |
| 5ac | 3y | 12 | 3.60 | 9.14 | 5.01 |
| 5ad | 3y | 12 | 4.32 | 9.20 | 5.13 |
| 5ae | 3aa | 90 | 27.08 | 8.87 | 4.66 |
| 5af | 3z | 15 | 2.90 | 8.66 | 4.20 |
| 5ag | 3z | 15 | 4.42 | 8.87 | 4.71 |
| 5ah | 3z | 15 | 5.67 | 9.07 | 5.20 |

### Example 6

Porous silica or hybrid particles are refluxed in toluene (175 mL, Fisher Scientific, Fairlawn, N.J.) for 1 hour. A Dean-Stark trap was used to remove trace water from the mixture. Upon cooling, imidazole (Aldrich, Milwaukee, Wis.) and one or more surface modifiers are added. The reaction is then heated to reflux for 16-18 hours. The reaction is then cooled and the product was filtered and washed successively with toluene, water, and acetone (all solvents from Fisher Scientific). The material is further refluxed in an acetone/aqueous 0.12 M ammonium acetate solution (Sigma Chemical Co., St. Louis, Mo.) for 2 hours. The reaction is cooled and the product is filtered and washed successively with water, and acetone (all solvents from Fisher Scientific). The product is dried at 70° C. under reduced pressure for 16 hours. The surface coverage is determined by the difference in particle % C before and after the surface modification using elemental analysis. Product can be further reacted with trimethylchlorosilane, trimethylchlorosilane, tri-n-butylchlorosilane, tri-1-propylchlorosilane, t-butyldimethylchlorosilane, or hexamethyldisilazane under similar conditions to further react surface silanol groups.

This general approach can be applied to a variety of different porous materials. Included in this spherical, granular, and irregular materials that are silica or hybrid inorganic/organic materials. The particles size for spherical, granular or irregular materials can vary from 0.4-3.0 μm; or from 1-3 μm. The APD for these materials can vary from 50 to 2,000 Å; or from 90 to 1000 Å; or from 120 to 450 Å. The TPV for these materials can vary from 0.5 to 1.7 cm³/g; or from 1.0 to 1.5 cm³/g; or from 1.1 to 1.4 cm³/g.

### Separation

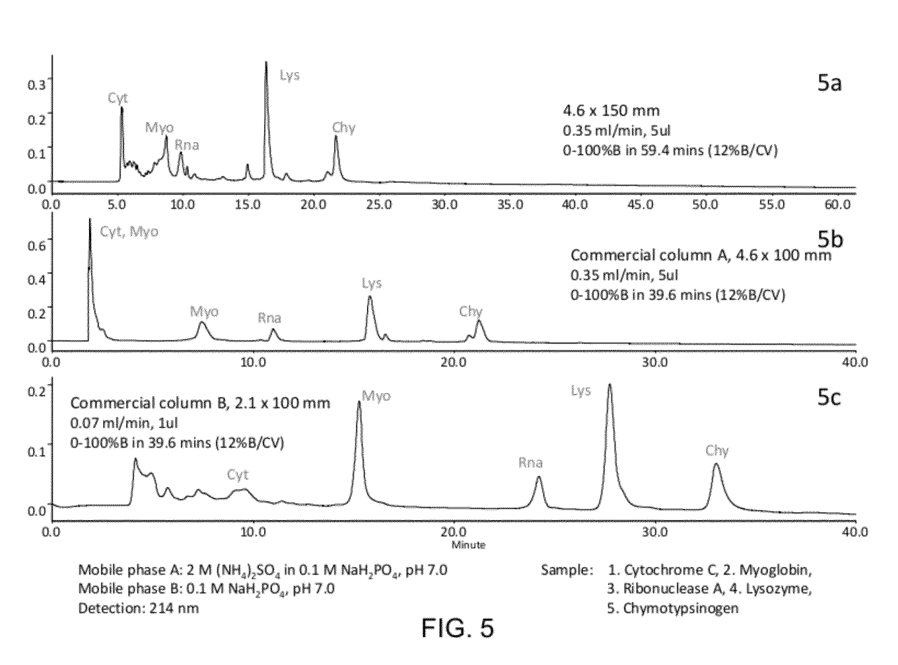

Referring to FIG. 5a, material with a particle size of about 1.7 micron, diol surface coverage of 5.43 mmol/m², surface area of 219 m²/g, pore volume of 1.26 cm³/g and pore diameter of 213 Å, was synthesized according to the method of Example 5. The material was packed into a 4.6×150 mm column to be used for the separation of a mixture of proteins. The chromatographic system consisted of an ACQUITY UPLC® system. Mobile phase A was 2 M (NH₄)₂SO₄ in 0.1 M NaH₂PO₄, pH 7.0, and mobile phase B was 0.1 M NaH₂PO₄, pH 7.0. A gradient of 0-100% B was run in 59.4 minutes. The flow rate was 0.35 mL/min, and the column temperature was at 30° C. The protein mixture consisted of cytocrome C, myoglobin, ribonuclease A, lysozyme and chymotrypsinogen, at a concentration of 1 mg/ml for each protein. 5 μL of the mixture was injected onto the column. The sample was detected at 214 nm.

In comparison to the technology described herein, separation of proteins was conducted in two different commercial columns, results for which are shown in FIGS. 5b and 5c. In FIG. 5b, a commercial butyl HIC column with a particle size of 2.5 micron and the dimension of 4.6×100 mm was used for the separation of a mixture of proteins. The chromatographic system consisted of an ACQUITY UPLC® system. Mobile phase A was 2 M (NH₄)₂SO₄ in 0.1 M NaH₂PO₄, pH 7.0, and mobile phase B was 0.1 M NaH₂PO₄, pH 7.0. A gradient of 0-100% B was run in 39.6 minutes. The flow rate was 0.35 mL/min, and the column temperature was at ambience. The protein mixture consisted of cytocrome C, myoglobin, ribonuclease A, lysozyme and chymotrypsinogen, at a concentration of 1 mg/ml for each protein. 5 μL of the mixture was injected onto the column. The sample was detected at 214 nm.

In FIG. 5c, a commercial amide/ethyl HIC column with a particle size of 5 micron and the dimension of 2.1×100 mm was used for the separation of a mixture of proteins. The chromatographic system consisted of an ACQUITY UPLC® system. Mobile phase A was 2 M (NH₄)₂SO₄ in 0.1 M NaH₂PO₄, pH 7.0, and mobile phase B was 0.1 M NaH₂PO₄, pH 7.0. A gradient of 0-100% B was run in 39.6 minutes. The flow rate was 0.07 mL/min, and the column temperature was at ambience. The protein mixture consisted of cytocrome C, myoglobin, ribonuclease A, lysozyme and chymotrypsinogen, at a concentration of 1 mg/ml for each protein. 1 μL of the mixture was injected onto the column. The sample was detected at 214 nm.

The gradient slope was the same in FIGS. 5a, 5b, and 5c, which was 12% B/column volume.

In comparing FIGS. 5a, 5b, and 5c the results showed better resolution, narrower peaks and shorter run time on the column packed with the material synthesized in accordance with the present technology than on the commercial columns.

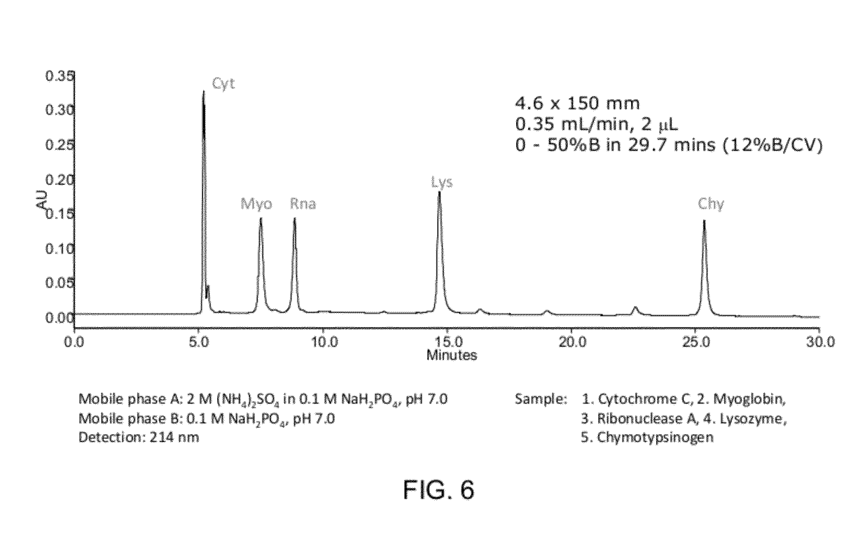

In FIG. 6, the material synthesized in accordance with Example 5 above was packed into a 4.6×150 mm column to be used for the separation of a mixture of proteins. The chromatographic system consisted of an ACQUITY UPLC® system. Mobile phase A was 2 M (NH₄)₂SO₄ in 0.1 M NaH₂PO₄, pH 7.0, and mobile phase B was 0.1 M NaH₂PO₄, pH 7.0. A gradient of 0-50% B was run in 29.7 minutes. The flow rate was 0.35 mL/min, and the column temperature was at 30° C. The protein mixture consisted of cytocrome C, myoglobin, ribonuclease A, lysozyme and chymotrypsinogen, at a concentration of 1 mg/ml for each protein. 2 μL of the mixture was injected onto the column. The sample was detected at 214 nm. The results shown in FIG. 6 illustrate a short run time as well as high resolution results.

### Example 7

Example 7 provides an illustration of the technology operating in step gradient mode, which has applications including sample preparation for fractionation of proteins, e.g., for a crude cleanup of proteins from plasma, such as when performing quantitative analysis of protein drugs in plasma.

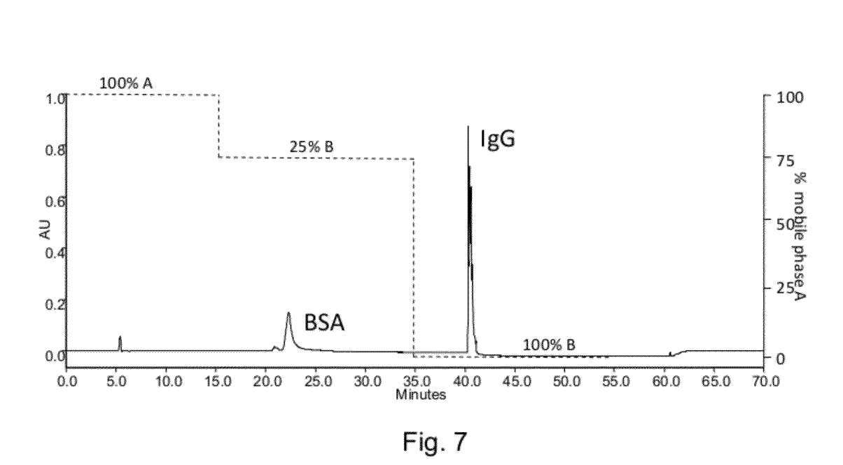

The material synthesized above was packed into a 4.6×150 mm column to be used for the separation of a mixture of Bovine Serum Albumin (BSA, 1.95 mg/ml) and Immunoglobulin G (IgG, 0.57 mg/ml). The chromatographic system in this example included an ACQUITY UPLC® system. Mobile phase A was 2 M (NH₄)₂SO₄ in 0.1 M NaH₂PO₄, pH 6.0, and mobile phase B was 0.1 M NaH₂PO₄, pH 6.0. A step gradient was performed as shown in FIG. 7. The flow rate was 0.35 ml/min, and the column temperature was 30° C. 5 μL of the mixture was injected onto the column. The sample was detected at 214 nm. As shown in FIG. 7, the sample was loaded onto the column using 100% mobile phase A. After 15 min, the mobile phase was changed to 25% mobile phase B. At 35 min, the mobile phase was changed to 100% mobile phase B. BSA eluted when mobile phase was 25% B, and IgG eluted at 100% B.

Although various aspects of the disclosed methods and kits have been shown and described, modifications may occur to those skilled in the art upon reading the specification. The present application includes such modifications.

What is claimed is:

1. A method for performing hydrophobic interaction chromatography comprising:
providing at least one wall defining a chamber having an inlet and an exit, and a stationary phase disposed within the chamber wherein the stationary phase comprises particles or monolith represented by Formula 1:
[X]-Q Formula 1
wherein X comprises a hydrophobic surface and Q comprises a hydrophilic ligand;
loading a sample onto the stationary phase in the chamber and flowing the sample over the stationary phase; and
separating the sample into one or more compositions by hydrophobic interaction between the stationary phase and the one or more compositions.

2. A separation method comprising:
providing a stationary phase represented by Formula 1:
[X]-Q Formula 1
wherein X comprises a hydrophobic surface and Q comprises a hydrophilic ligand;
contacting a sample and the stationary phase; and
separating the sample into one or more compositions by hydrophobic interaction between the stationary phase and the one or more compositions.

3. The method of claim 1, wherein flowing the sample over the stationary phase is carried out at an inlet pressure greater than 1,000 psi.

4. The method of claim 1, wherein flowing the sample over the stationary phase is carried out at an inlet pressure greater than 5,000 psi.

5. The method of claim 1, wherein flowing the sample over the stationary phase is carried out at an inlet pressure greater than 7,000 psi.

6. The method of claim 1, wherein flowing the sample over the stationary phase is carried out at an inlet pressure greater than 10,000 psi.

7. The method of claim 1 or 2, further comprising the step of:
isolating the one or more compositions.

8. The method of claim 1 or 2, further comprising the step of:
detecting the one or more compositions.

9. The method of claim 1 or 2, wherein the sample comprises one or more biopolymers.

10. The method of claim 1 or 2, wherein the hydrophobic surface comprises a hydrophobic monolayer.

11. The method of claim 1 or 2, wherein X comprises a hydrophobic core.

12. The method of claim 1 or 2, wherein X comprises a silica core, a titanium oxide core, an aluminum oxide core, an iron oxide core, or an organic-inorganic hybrid core.

13. The method of claim 1 or 2, wherein X comprises an organic-inorganic hybrid core comprising an aliphatic bridged silane.

14. The method of claim 13, wherein the aliphatic bridged silane is ethylene bridged silane.

15. The method of claim 1 or 2, wherein Q is an aliphatic group.

16. The method of claim 15, wherein the aliphatic group is an aliphatic hydroxyl group.

17. The method of claim 16, wherein the aliphatic hydroxyl group is a diol.

18. A separation method comprising:
providing a solid stationary phase comprising a hydrophobic surface and a plurality of hydrophilic ligands attached thereto;
contacting a liquid sample and the solid stationary phase, wherein the liquid sample potentially comprises one or more analytes; and
separating the one or more analytes, if present, from the sample through hydrophobic interaction between the one or more analytes and the stationary phase.

19. The method of claim 18, further comprising using a hydrophobic interaction chromatography solvent system, to separate the one or more analytes from the sample through hydrophobic interaction chromatography.

20. The method of claim 19, wherein the solvent system comprises an aqueous buffer.

21. The method of claim 19, wherein the solvent system comprises a salt gradient.

22. The method of claim 18, wherein the solid stationary phase comprises ethylene bridged hybrid (BEH) particles.

23. The method of claim 18, wherein the solid stationary phase comprises particles having a mean size between about 1 and 2 microns.

24. The method of claim 18, wherein the solid stationary phase comprises particles having a mean size between about 2 and 25 microns.

25. The method of claim 18, wherein the solid stationary phase comprises particles having a mean size between about 25 and 50 microns.

26. The method of claim 18, wherein the solid stationary phase comprises porous particles.

27. The method of claim 18, wherein the solid stationary phase comprises nonporous particles.

28. The method of claim 18, wherein the solid stationary phase comprises a monolith.

29. The method of claim 18, wherein the solid stationary phase comprises chromatographic fibers.

30. The method of claim 18, wherein the solid stationary phase comprises a magnetic bead core having the hydrophobic surface.

31. The method of claim 30, wherein the solid stationary phase comprises particles having a mean size between about 7 and 10 microns.

32. The method of claim 18, wherein the ligands consist essentially of a single type of ligand.

33. The method of claim 18, wherein the ligands each comprise an alcohol.

34. The method of claim 18, wherein the ligands each comprise a diol.

35. The method of claim 18, wherein the ligands each comprise an ether.

36. The method of claim 18, wherein the ligands each comprise an amide.

37. The method of claim 18, wherein the hydrophobic surface comprises a coating on the solid stationary phase.

38. The method of claim 18, wherein the hydrophobic surface is integral with the solid stationary phase.

39. The method of claim 18, wherein the sample comprises one or more biopolymers.

40. A hydrophobic interaction chromatography method comprising:
providing a solid stationary phase comprising ethylene bridged hybrid (BEH) particles having a hydrophobic surface and a plurality of diol ligands attached thereto;
contacting a liquid sample and the solid stationary phase, wherein the liquid sample potentially comprises one or more protein analytes; and
separating the one or more protein analytes, if present, from the sample through hydrophobic interaction between the one or more protein analytes and the stationary phase.

41. A kit for hydrophobic interaction chromatography comprising:
a solid stationary phase comprising a hydrophobic surface and a plurality of hydrophilic ligands attached thereto; and
instructions for (i) contacting a liquid sample and the solid stationary phase, wherein the liquid sample potentially comprises one or more analytes and (ii) separating the one or more analytes, if present, from the sample through hydrophobic interaction between the one or more analytes and the stationary phase.

42. The kit of claim 41, wherein the solid stationary phase comprises ethylene bridged hybrid (BEH) particles having a hydrophobic surface and a plurality of diol ligands attached thereto.
